(19) United States
(12) Patent Application Publication
(10) Pub. No.: US 2017/0124881 A1
(43) Pub. Date: May 4, 2017

(54) BLIND ZONE WARNING FOR SEMI-TRAILER

(71) Applicant: Peter J. Whitehead, Williamsburg, VA (US)

(72) Inventor: Peter J. Whitehead, Williamsburg, VA (US)

(73) Assignee: VELVAC INCORPORATED, New Berlin, WI (US)

(21) Appl. No.: 15/334,867

(22) Filed: Oct. 26, 2016

Related U.S. Application Data
(60) Provisional application No. 62/247,522, filed on Oct. 28, 2015.

(51) Int. Cl. G08G 1/16; B60Q 9/00; B60R 1/00

(52) U.S. Cl. CPC G08G 1/167; B60R 1/002; B60Q 9/008; B60R 2300/8093; B60R 2300/804; B60R 2300/105; B60R 2300/205

(57) ABSTRACT

A system for detecting objects in a blind spot of a vehicle provides detectors and/or cameras mounted at or near the top of the vehicle and at or near a center of each side of the vehicle. A camera or sensor may be provided at the top center of each side of a semi-trailer to provide a down directed view at each side of the trailer. A sensor or camera may also be provided at the top center of the back of the trailer and at or near the top of the trailer.

### CROSS REFERENCE TO RELATED APPLICATION

The present application claims the benefit of U.S. Provisional Patent Application Ser. No. 62/247,522, filed on Oct. 28, 2015, which application is incorporated herein by reference.

### BACKGROUND OF THE INVENTION

Field of the Invention

The present invention relates generally to a proximity warning system for a vehicle, and more particularly to a vehicle proximity sensor and warning system for a semi-tractor trailer.

Description of the Related Art

There are many blind zone warning systems available, some are camera based others sense by radar, they all share the same fault when applied to a semi-truck. The problem is when turning the trailer comes within the detection zone and appears as a danger resulting in a false positive warning. Reliable detection in the adjacent lane for the full length of the vehicle including the trailer is going to be critical for autonomous vehicles which need to know the lane is clear before making a lane change, and without a driver in active control of the vehicle an electronic detection system will be required.

Attempts have been made to overcome this problem by attaching a radar antenna to the side of the trailer but as the computer that decodes the signal has to be close to the antenna, this becomes a very expensive method of detecting as every trailer has to be fitted with a full sensor and decoder system.

Camera based systems typically have a camera mounted in close proximity to the rear view mirror looking rearward covering the same basic area as is visible in the mirror. The sensing works primarily by identifying a significant feature on an approaching object and tracking it. This pixel progression is effective at short range but not applicable at a distance. Due to the shallow angle the movement of an object is difficult to measure.

Radar falls into several types, the simplest being Doppler, this has been used for detecting moving objects for many years. The weakness of this form of radar is the difficulty in controlling the detection zone. Secondly it normally only detects advancing vehicles. This form of detection means the sensor is pointing rearward and would detect the trailer during a turn.

The advent of patch antennas has seen the development of radars that can plot the position and movement of an object in a very accurately defined sensing zone. Typically these antennas are arranged to look sideways and scan up to 180 deg. This covers a wide area but still typically has a problem detecting the movement of a trailer in the sensing zone leading to a false signal.

### SUMMARY OF THE INVENTION

The present invention provides a camera mounted on either side of a trailer preferably near the mid-point and as high as practical, aimed out and down. By selecting a lens with the appropriate field of view (probably 130 deg.) the entire lane adjacent to the trailer and at least as long as the trailer can be viewed. A similar arrangement on the semi-tractor enables the entire length of the adjacent roadway lane next to the tractor trailer to be viewed. Due to the placement and alignment of the cameras the view is essentially looking down from above towards the road. With this view of vehicles in the adjacent lane they appear as if looking down from above which makes it very easy to plot the relative movement relative to the semi. The plan view enables a high degree of accuracy in plotting the movement of adjacent vehicles. The image from these cameras is processed and analyzed by a detector, or detection algorithm which identifies the object and plots its movement in order to classify the object as a potential threat. Examples of the technique are pixel tracking and object recognition. There are several other techniques employed in current blind zone warning devices, these are all applicable to this application. The unique positioning of the cameras and targeting improves the effectiveness of these algorithms.

More importantly the vehicles next to the tractor and those next to the trailer are regarded as separate entities; the field of view can be arranged such that the trailer may never appear in the tractor unit cameras field of view during a turn, avoiding the problem of false warnings due to the trailer.

It is likely that during a turn a vehicle detected by the trailer may also be detected by the tractor sensors, this is not a problem. This principal may be applied to vehicles towing multiple trailers, or to a trailer attached by a conventional ball-type tow hitch not just for 5th wheel attachments.

To enhance the protection a camera may also be added to the rear of the trailer with a similar zone only this time viewing the lane the semi is in and the lane to the left and right. The FOV (field of view) can be extended rearward to give additional advanced notification of approaching vehicles.

A forward camera may also be employed to warn of potential impact.

To avoid false alerts when passing stationary objects, the objects can be identified and the relative speed compared to the vehicle speed as recorded by the vehicle and available through a local area network such as the CAN BUS, or GPS. This is a common technique to remove unwanted stationary objects from triggering an alarm.

The image from the cameras may also be used to assist in low speed maneuvering by displaying the image on a screen. The image displayed may either be realistic (feed direct from the camera) or in the form of an artificial representation of the vehicles using the processed data.

An alternative arrangement, the trailer layout remains the same but the semi-tractor cameras are mounted near the front and arranged to view rearward. The blind zone sensing is really only effective at fairly short range so should not be affected by the trailer during a turn. The advantage of this arrangement is the camera also provides a good usable view for the driver (replacing a convex hood mounted mirror).

This arrangement is not restricted to vehicles with trailers; it is equally as effective at covering a long rigid vehicle such as a delivery truck or RV.

An additional benefit is the only addition to the trailer is 2 or 3 cameras; the expensive processing unit can reside in the truck, protected from damage. With this approach the unit cost per trailer is kept low.

The same trailer configuration may be used when the tractor sensor system is radar based as long as it is only scanning alongside the tractor and not rearward facing.

### BRIEF DESCRIPTION OF THE DRAWINGS

FIG. 1 is a top plan view of a semi-tractor trailer truck showing blind spot detection zones;

FIG. 2 is a top view of the semi-tractor trailer truck showing the change in blind spot detection zones during truck turning;

FIG. 3 is a side elevational view of the semi-tractor trailer truck showing the blind zone detectors;

FIG. 4 is a front perspective view of the semi-tractor trailer truck showing the blind zone detectors;

FIG. 5 is a top view of a semi-tractor trailer truck showing blind spot detection zones of a further embodiment;

FIG. 6 is a top view of the semi-tractor trailer truck of FIG. 5 showing the change in blind spot detection zones during truck turning;

FIG. 7 is a side view of the semi-tractor trailer truck of FIG. 5 showing the camera and detector locations; and

FIG. 8 is a functional block diagram of a blind zone warning system for a semi-tractor trailer.

### DETAILED DESCRIPTION OF THE PREFERRED EMBODIMENTS

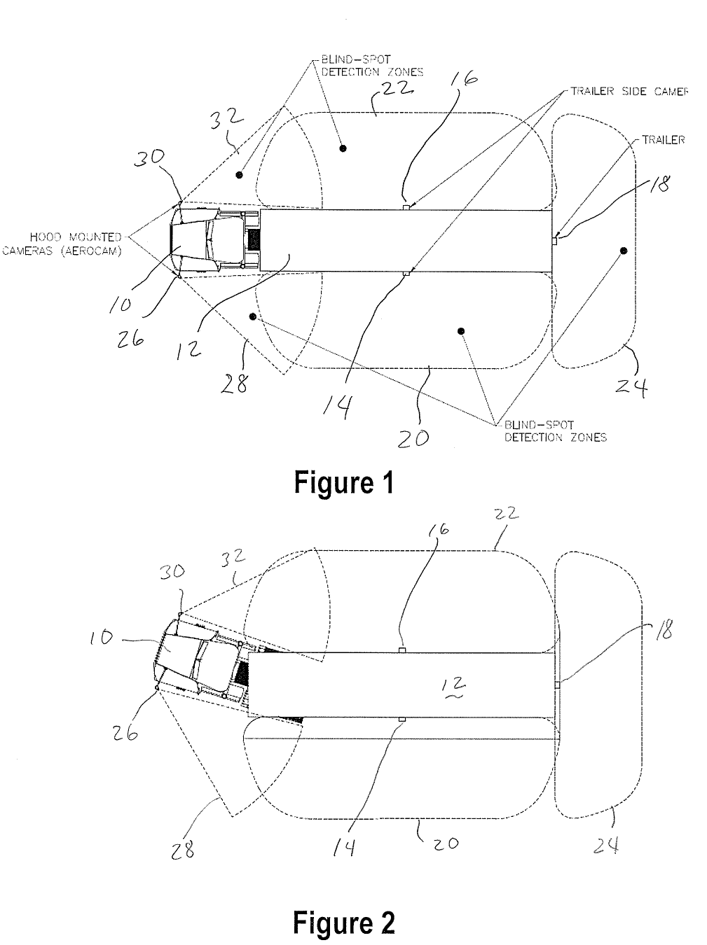

In FIG. 1, a semi-tractor 10 is connected to a semi-trailer 12. The connection between the tractor 10 and the trailer 12 is typically by a fifth wheel connection, although a ball hitch or other connection may be provided as well. The tractor 10 typically is provided with mirrors that are mounted to provide a view behind the tractor and trailer for the driver of the tractor 10. No matter how well placed the mirrors are, there remain areas of limited or no visibility to the driver. These areas of limited or no visibility may be referred to as blind spots. The blind spots may include areas along both sides of the trailer 12 and behind the trailer 12. Semi-tractor trailers often are provided with signs warning drivers of nearby vehicles that the driver of the semi-truck may not be able to see their vehicle at certain locations around the semi-truck.

The tractor trailer 10 and 12 is provided with a driver side camera and detector 14 at or near a center of the side of the trailer 12 on the driver's side. A passenger side camera and detector 16 is provided on the passenger side of the trailer 12 at or near the center of that side. A rear camera and detector 18 is provided at the rear of the trailer 12, for example at the center of the rear of the trailer. The reference to a camera and detector in this specification may include a combined camera and detector, separate camera and separate detector, only a camera, or only a detector. The camera may be a video camera or a still camera or other camera. The detector may be an object detector, a motion detector, a proximity detector, or other detector. The detector may include an optical sensor, ultrasound sensor, electrical sensor, magnetic sensor, or other detector.

The driver side camera and detector 14 is mounted and configured to provide a viewing and detection zone 20 that extends along the side of the trailer 12. In the example, the detection zone extends from the front of the trailer 12 to the back of the trailer 12 and extends from immediately adjacent the side of the trailer outward a lateral distance. In the illustrated embodiment, the lateral distance is approximately 1.5 times the width of the trailer 12. The passenger side camera and detector 16 is similarly mounted and configured to provide a viewing and detection zone 22 from the front to the back of the trailer 12 and from immediately adjacent the side of the trailer 12 out to a lateral distance of approximately 1.5 times the width of the trailer 12. The combined detection zones 20 and 22 extend laterally approximately 4 times the width of the trailer 12. Other detection zones may be provided instead.

The rear camera and detector 18 provides a viewing and detection zone 24 that extends from immediately adjacent to the rear of the trailer 12 rearward a distance approximately 1.3 times the width of the trailer. The rear viewing and detection zone 24 extends laterally to or nearly to the full lateral extent of the combined detection and viewing zones 20 and 22 provided by the side cameras 14 and 16.

The tractor 10 may also be provided with cameras and detectors. For instance, a driver side hood mounted camera and detector 26 is provided on the hood, fender or other part of the tractor 10 or on a mount such as a mirror mount or arm. The driver side camera and detector 26 provides a viewing and detecting zone 28 that extends rearwardly from immediately alongside the side of the tractor and outward from the side of the tractor 10. A passenger side camera and detector 30 is mounted on the hood, fender or other body part of the tractor 10 on a mount such as a mirror mount or arm. The passenger side camera 30 provides a sidewardly and rearwardly directed view 32 similar to the driver's side camera.

The cameras and detectors 14, 16, 18, 26 and 30, may be cameras such as video cameras, which provide video information to a display screen in the cab of the truck. The driver may be able to see objects in the zones 20, 22, 24, 28 and 32 on the screen, and just as important, may be able to determine that there are no objects in the zones. The cameras and detectors may be only cameras. The cameras and detectors 14, 16, 18, 26 and 30 may include proximity detectors or other detectors that detect objects in the detection zones 20, 22, 24, 28 and 32. The cameras and detectors may be both cameras and detectors. The cameras and detectors may be only detectors.

The detectors may operate to detect moving objects or to detect motion relative to the semi-tractor trailer 10 and 12 and the object. The detectors may ignore stationary objects or objects that are fixed relative to the semi-tractor trailer 10 and 12 or may detect and report such objects. The detectors may trigger warning sounds, lights, displays and/or other indicia in the cab of the tractor 10 upon detection of an object in at least one of the detection zones. The detectors may detect moving objects such as other vehicles, or objects which move relative to the truck, such as detecting and alerting the driver to stationary objects as the truck is moving.

As seen in FIG. 2, for mirrors or detectors 26 and 30 that are on the tractor 10, the detection zones 28 and 32 move relative to the trailer 12 as the truck turns, resulting in blind spots occurring or increasing in size compared to when the truck is not turning. For example, the angled position of the trailer 12 relative to the tractor 10 during turning causes the trailer 12 to block the views from the tractor 10, whether those views are the direct view of the driver, the view via mirrors mounted on the tractor, or the views via cameras or detectors mounted on the tractor. The result is blind spots for the driver. By contrast, the detection zones 20, 22 and 24 for the cameras and detectors 14, 16 and 18 mounted on the trailer 12 remain stationary relative to the trailer 12 during turning, avoiding blind spots caused by the trailer during turning. FIG. 2 shows that the detection zones 20, 22 and 24 on the trailer 12 remain fixed relative to the trailer 12 when the truck turns. The cameras and detectors 26 and 30 that are mounted on the tractor 10 move the zones of detection relative to the trailer 12 as the truck is turned, potentially creating blind spots. The zones of detection 20, 22 and 24 for the trailer cameras and detectors 14, 16 and 18 overlap with the zones of detection 28 and 32 for the tractor cameras and detectors 26 and 30 so that the blind spots which would otherwise occur are covered by other cameras and detectors.

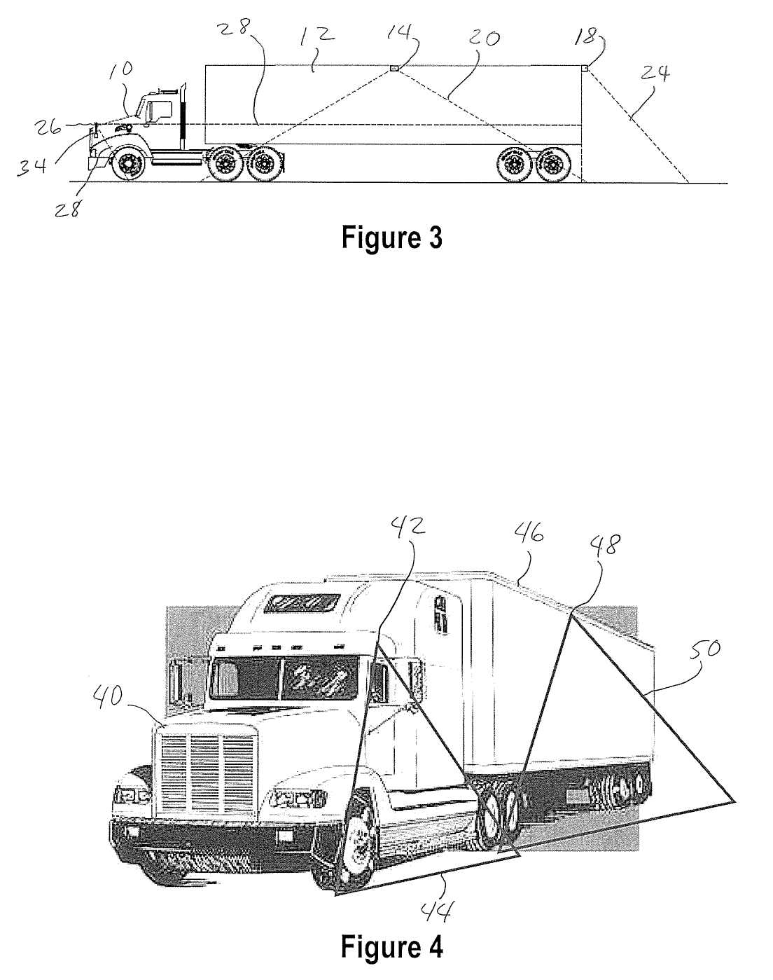

FIG. 3 shows that the trailer 12 has the camera and detector 14 mounted at or near the top of the trailer 12 and directed downwardly so that the zone of detection 20 is at its fullest extent at the pavement or ground on which the truck is supported. The camera and detector 16 on the other side is similarly mounted at or near the top of the trailer 12. The rear camera and detector 18 is mounted at or near the top of the trailer 12 to provide a zone of detection 24 that extends outward at its fullest extent at the ground or pavement. Objects on or near the ground or pavement are detected over the full extent of the zone of detection. Objects that are higher off the ground or pavement may not enter the zone of detection until they are closer to the trailer 12.

The tractor 10 has the camera and detector 26 mounted on a support 34 extending from the hood of the tractor 10. The camera and detector 26 has a zone of detection 28 that extends from adjacent to the tractor 10 along the full length of the tractor 10 and the trailer 12 when the truck is not turning. The detection zone 28 is low and detects objects at or a short distance from the ground or pavement, such as up to several feet from the ground. The detection zone 28 is alongside the trailer 12 during straight travel, but during turning as the tractor and trailer move relative to one another, so too the detection zone 28 is moved relative to the trailer 12 during turning with the result that parts of the detection zone 28 are blocked by the trailer 12.

FIG. 4 shows an alternate embodiment. The tractor 40 has a camera and detector 42 mounted near or at the top of the cab of the tractor 40. The camera and detector 42 is directed downward to define a detection zone 44 that extends along the side of the tractor and outward. A similar camera and detector is mounted on the opposite side of the tractor 40. The trailer 46 has a camera and detector 48 mounted at the top and directed downward to define a detection zone 50 that extends along the side of the trailer 46 and outward from the side. The detection zone 50 may be similar or identical to the zone 20 of FIG. 1. Cameras and detectors are provided on the opposite side as well as at the back like the first embodiment.

The downward looking camera and detector 42 may be in addition to the camera and detector 26 on the hood, or may be used in place of the detector 26.

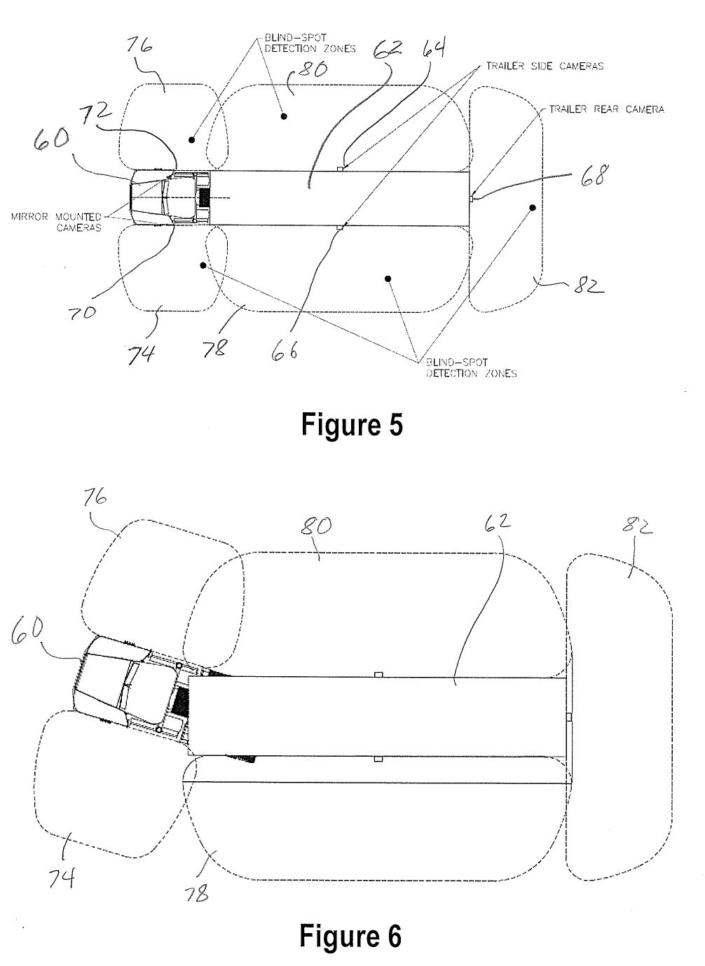

FIG. 5 shows a top view of a semi-tractor trailer truck 60 having cameras and detectors 64, 66 and 68 mounted on the trailer 62 as in FIG. 1. The tractor 60 has cameras and detectors 70 and 72 mounted on the side mirrors of the tractor 60. The cameras and detectors provide detection zones 74 and 76 which are alongside the cab portion of the tractor 60. The tractor detection zones 74 and 76 overlap side detection zones 78 and 80 defined by the cameras 66 and 64 on the trailer 62. The rear camera and detector 68 defines a detection zone 82 at the back of the trailer 62.

FIG. 6 shows the truck 60 turning. During turning, the tractor side detection zones 74 and 76 are rotated relative to the trailer side detection zones 78 and 80. Even with the turning of the truck, the detection zones overlap or nearly overlap as between the tractor and the trailer. Blind spots are avoided during turning of the truck 60.

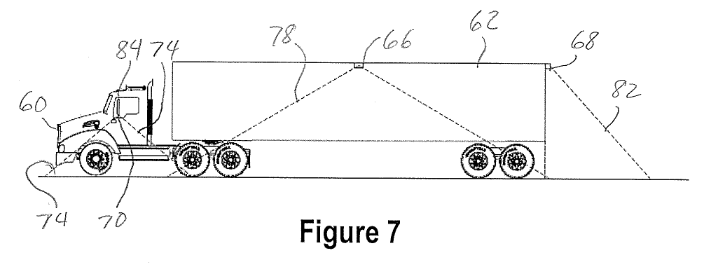

In FIG. 7, the truck 60 has the cameras and detectors 66 and 68 mounted adjacent to the top of the trailer 62 and directed downward to define detection zones 78 and 82. The tractor 60 has a camera and detector 70 mounted on a lower portion of an external side mirror 84. The camera and detector 70 may be mounted within a mirror housing of the side mirror 84 or external to the side mirror housing. In the example, the camera and detector 70 is mounted at a lower portion of the housing of the side mirror 84 and directed downward from the underside of the mirror housing.

The downward directed cameras and detectors mounted at the top of the trailer provide a top down view of the road and surrounding area around the truck. Detection of an object which may be behind another object is possible. For example, if a second vehicle is behind a first vehicle, the second vehicle might not be detected by viewing the mirrors or even by using detectors with a view parallel to the road surface. A top down view however may be able to view or detect the second vehicle, even if the first vehicle is larger or if the second vehicle is close behind the first vehicle. The trailer mounted detectors and cameras may detect the second vehicle or second object even if it would otherwise be hidden by a first vehicle or object. Added safety is provided.

The detection zones of the trailer remain fixed relative to the trailer during turning to avoid false positives caused by detectors on the tractor detecting the trailer as a moving object during turning. The cameras and detectors on the trailer will not sense the trailer as a moving object during turning of the truck.

Blind spots are avoided by the trailer mounted cameras and detectors. The cameras and detectors overlap, even during turning.

A image viewing system is provided in the cab of the tractor 10. The viewing system is connected to receive video information from the cameras. For example, a display panel that is built into the interior of the driver compartment or a portable display panel that is placed into the interior of the driver compartment may be connected to view the video data from the cameras. The display panel may include a tablet computer, smart phone, navigation system, GPS system, game system, personal digital assistant, e-book reader, or other electronic device on which the video signal is displayed. The video signal may be transmitted to the display panel by wired or wireless connection. The display may automatically change depending upon detection of an object by a detector or by an object entering or moving in the field of view of a camera. For example, the display panel may show a view of the video camera signal from a video camera and detector that has detected an object of interest, such as a vehicle or obstacle that may not be otherwise visible to the driver.

The processing and display of the video signals and detector signals may be provided according to U.S. Pat. No. 9,387,813 and co-pending U.S. patent applications Ser. No. 13/838,081 and Ser. No. 15/206,444, each of which are incorporated herein by reference.

In an alternate embodiment, an alert indicator is provided in the cab of the tractor that is connected to receive alerts from the detectors. For example, a warning light, warning sound or warning display, or combination of any or all of those, may activate in the vehicle to alert the driver to an obstacle or vehicle detected by a detector. Both image viewing and alert indicators may be provided in the cab or driver compartment of the vehicle.

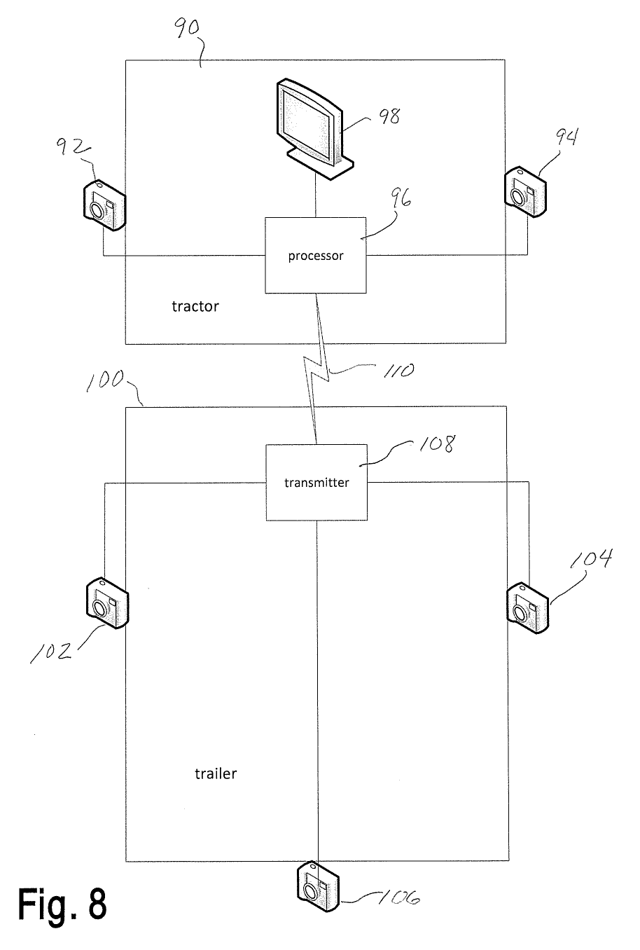

Referring to FIG. 8, a tractor 90 of a semi-tractor trailer is provided with a driver side camera and detector 92 mounted to provide a view and to detect objects on the driver side of the tractor 90. A passenger side camera and detector 94 is mounted to provide a view and/or to detect objects on the passenger side of the tractor 90. The cameras 92 and 94 are represented in the drawing by a camera symbol. In practice, the cameras 92 and 94 are directed as needed to provide the views described herein. The cameras 92 and 94 may include detectors, or detectors may be provided instead of cameras. The cameras and/or detectors may be mounted as shown or in other mounting locations.

The cameras 92 and 94 of certain embodiments are video cameras which have outputs connected to a processor 96 that is provided in or on the tractor 90. The processor 96 operates to process the video signal and to display the video images by the cameras on a display panel 98 in the tractor 90. The display panel 98 displays the video signal of one or any combination of video camera outputs in any arrangement desired. The display panel 98 may switch displays or display arrangements depending on detection of objects by the cameras and/and detectors or depending on actions by the driver, such as turning the vehicle or using the turn signal of the vehicle. The processor 96 may process the video signal, such as providing a mirror image of the video signal or other processing. The processor 96 may record the video signal. The processor 96 may process detector signals where detectors are provided.

The display panel 98 may be a built-in display panel in the tractor 90 or other vehicle, or may be a stand-alone display. For example, the display panel 98 may be a tablet computer or other device having a display. The display panel 98 may display or otherwise announce alerts, such as the presence of an object in a blind spot during turning, by sounds, lights, vibrations, or other means for announcing an alert. The alert may be announced by a light, sound, vibration or other announcing means in the vehicle, such as by an indicator built into the vehicle.

In FIG. 8, the tractor 90 is towing a trailer 100. The trailer 100 may be a trailer of a semi-tractor trailer. It is also foreseen that the trailer may be a cargo trailer, recreational trailer, camping trailer, livestock trailer, or other trailer being towed by a truck, car, SUV, or other vehicle. In the illustrated example, a driver side camera and detector 102 is mounted on the driver's side of the trailer 100. A passenger side camera and detector 104 is mounted on the passenger side of the trailer 100. A rear camera and detector 106 is mounted on the rear of the trailer 100. Each of the cameras and detectors 102, 104, and 106 are directed to view and detect objects within the detection areas shown and described elsewhere in the present specification and drawings.

The outputs of the cameras and detectors 102, 104, and 106 are connected to a transmitter 108 in the illustrated embodiment. The transmitter 108 operates to transmit video signals and/or detection signals from the cameras and detectors 102, 104, and 106 to the processor 96 in the tractor 90 or other vehicle. The transmission of the signals is by wireless transmission 110 from the transmitter 108 to the processor 96, in this example. The wireless transmission may be by Bluetooth, Wi-Fi, Internet of Things, or other wireless transmission standards. The video and/or detector signals may be transmitted by wired connection in certain embodiments such as by a wired network connection.

The transmitter 108 may include a processor to process the signals prior to transmission or may transmit the unprocessed signals from the cameras and detectors 102, 104 and 106. The cameras and detectors 102, 104 and 106 may be directly connected to the processor 96 such as by wired or wireless connection instead of being connected through a transmitter 108. More or fewer cameras and/or detectors may be provided on the trailer 100, including in other mounting locations and/or directed in other directions than shown.

The present system and method may be particularly advantageous for dual trailer, triple trailer trucks, or other long combination vehicles. A set of cameras and/or detectors may be provided on each trailer of a multi-trailer rig. The present system and method may be used for trailers towed by vehicles having poor visibility for the driver to objects behind the vehicle. For example, a driver of a motor home, bus, or other large vehicle may benefit from the present system or method when towing a trailer or second vehicle. Detection of an object or a view of an object near the trailer may be provided to the driver of the motor home or other vehicle.

In a first embodiment, a system for detecting objects in a blind spot of a vehicle, comprising: a trailer of a semi-tractor trailer having a trailer housing, the trailer having a coupling for connection to a tractor; first, second and third cameras and detectors mounted adjacent to a top of the trailer and directed downwardly and outwardly from respective first, second and third sides of the trailer, the cameras and detectors being operable to detect an object within a detection zone of the cameras and detectors; and a user interface in the tractor to provide at least one of a detector signal or a video from at least one of the first and second and third cameras and detectors upon detecting an object within the detection zone.

In a second embodiment, a system of the first embodiment, further comprising: fourth and fifth cameras and detectors mounted on the tractor and directed downward and adjacent to the tractor, the fourth and fifth cameras and detectors being connected to transmit at least one of detector signals and video signals to the user interface.

In a third embodiment, a system of the second embodiment, wherein the fourth and fifth cameras and detectors are mounted in a mirror mount of the tractor.

In a fourth embodiment, a system of the first embodiment, wherein the cameras and detectors include video cameras.

In a fifth embodiment, a system of the fourth embodiment, wherein the user interface includes a video display screen.

In a sixth embodiment, a system of the first embodiment, wherein the cameras and detectors include object detectors.

In a seventh embodiment, a system of the sixth embodiment, wherein the user interface includes an indicator that operates to indicate an object detected in the detection zone.

In an eighth embodiment, a system of the first embodiment, wherein the first and second cameras and detectors are mounted adjacent a top of the trailer approximately midway along opposite sides of the trailer.

In a ninth embodiment, a method for detecting objects adjacent to a tractor trailer, comprising: directing a plurality of cameras and detectors from a top of a trailer to a plurality of detection zones disposed adjacent to the trailer, the detection zones extending from adjacent to the trailer outward a predetermined distance, the detection zones extending for at least a full length of the trailer; detecting an object in at least one of the detection zones; and alerting a driver of the tractor trailer of the detection of the object.

Thus, there is shown and described a system for detecting objects in a blind spot of a vehicle provides detectors and/or cameras mounted at or near the top of the vehicle and at or near a center of each side of the vehicle. A camera or sensor may be provided at the top center of each side of a semi-trailer to provide a down directed view at each side of the trailer. A sensor or camera may also be provided at the top center of the back of the trailer and at or near the top of the trailer.

Although other modifications and changes may be suggested by those skilled in the art, it is the intention of the inventors to embody within the patent warranted hereon all changes and modifications as reasonably and properly come within the scope of their contribution to the art.

I claim:

1. A system for detecting objects in a blind spot of a vehicle, comprising:
a trailer of a semi-tractor trailer having a trailer housing, the trailer having a coupling for connection to a tractor;
first, second and third cameras and detectors mounted adjacent to a top of the trailer and directed downwardly and outwardly from respective first, second and third sides of the trailer, the cameras and detectors being operable to detect an object within a detection zone of the cameras and detectors; and
a user interface in the tractor to provide at least one of a detector signal or a video from at least one of the first and second and third cameras and detectors upon detecting an object within the detection zone.

2. A system as claimed in claim 1, further comprising:
fourth and fifth cameras and detectors mounted on the tractor and directed downward and adjacent to the tractor, the fourth and fifth cameras and detectors being connected to transmit at least one of detector signals and video signals to the user interface.

3. A system as claimed in claim 2, wherein the fourth and fifth cameras and detectors are mounted in a mirror mount of the tractor.

4. A system as claimed in claim 1, wherein the cameras and detectors include video cameras.

5. A system as claimed in claim 4, wherein the user interface includes a video display screen.

6. A system as claimed in claim 1, wherein the cameras and detectors include object detectors.

7. A system as claimed in claim 6, wherein the user interface includes an indicator that operates to indicate an object detected in the detection zone.

8. A system as claimed in claim 1, wherein the first and second cameras and detectors are mounted adjacent a top of the trailer approximately midway along opposite sides of the trailer.

9. A method for detecting objects adjacent to a tractor trailer, comprising:
directing a plurality of cameras and detectors from a top of a trailer to a plurality of detection zones disposed adjacent to the trailer, the detection zones extending from adjacent to the trailer outward a predetermined distance, the detection zones extending for at least a full length of the trailer;
detecting an object in at least one of the detection zones; and
alerting a driver of the tractor trailer of the detection of the object.
